(19) United States
(12) Patent Application Publication
(10) Pub. No.: US 2014/0064638 A1
(43) Pub. Date: Mar. 6, 2014

(54) APPARATUS AND METHOD FOR PROVIDING MEDICAL SUPPORT

(71) Applicant: FUJIFILM Corporation, Tokyo (JP)

(72) Inventor: Yasunori Ohta, Ashigarakami-gun (JP)

(73) Assignee: FUJIFILM Corporation, Tokyo (JP)

(21) Appl. No.: 13/954,880

(22) Filed: Jul. 30, 2013

(30) Foreign Application Priority Data
Aug. 30, 2012 (JP) 2012-190377

(51) Int. Cl. G06T 3/40

(52) U.S. Cl. CPC G06T 3/40
USPC 382/299

(57) ABSTRACT

A resize process is performed on an examination image to produce a high quality image and a low quality image. Image quality of the low quality image is lower than that of the high quality image. A distribution controller transmits the high quality image to a support terminal of a registered support medical staff who provides medical support based on the examination image. The distribution controller transmits the low quality image to a support terminal of a registered support medical staff who does not provide the medical support based on the examination image.

### BACKGROUND OF THE INVENTION

1. Field of the Invention

The present invention relates to an apparatus and a method for providing medical support.

2. Description Related to the Prior Art

A medical support system which allows distribution or transmission of data to medical staffs and exchanging of opinions between the medical staffs through the Internet or like is known. The data includes the status of treatment of a patient, an examination result, an examination image, and the like. In the medical support system, a terminal of a requester (primary care physician) of medical support and terminals of support medical staffs capable of participating in the medical support are connected through a network. The medical support is provided to the requester through the medical support apparatus. The medical support apparatus comprises a data acquisition section and a distribution section. The data acquisition section acquires data such as an examination image and a comment necessary for the medical support. The distribution section distributes or transmits the acquired data to the terminals. With the use of the medical support apparatus, the primary care physician performs diagnosis and treatment based on advice from a specialist physician (hereinafter simply referred to as the specialist) and the like, being a support medical staff, and a nurse retrieves the status of the treatment to prepare for a medical procedure based on the advice of the support medical staff, for example.

Technology to perform image distribution while preventing overload in image processing is known (see Japanese Patent Laid-Open Publication No. 2005-223430.) Using this technology, quality (for example, the number of pixels and a frame) of an image is determined based on environmental and operational information of a terminal to which the image is transmitted. Technology to transmit an image after the image is resized to a predetermined size (resolution) set in accordance with a terminal which receives the image is known (see Japanese Patent Laid-Open Publication No. 2005-295301). An image resized to a size suitable for a model of a PC terminal used is transmitted to the PC terminal. An image resized to a size suitable for a model of a mobile terminal used is transmitted to the mobile terminal.

The terminals are connected to a network to communicate data with each other. Portable terminals, for example, smart phones and tablet terminals, are normally connected to the network wirelessly. In the wireless communication, data communication speed is often slow. A load on the network increases when medical images such as examination images are distributed to the terminals successively. In this state, each terminal needs a long time to receive an image. The load on the network is reduced by changing resolution of the examination images in accordance with performance and environment of the terminals to which the examination images are transmitted, or distributing the examination images with uniform low resolution. In this case, however, appropriate diagnosis cannot be made because the resolution of the examination image does not meet a required level.

### SUMMARY OF THE INVENTION

An object of the present invention is to provide an apparatus and a method for providing medical support, capable of delivering a medical image such as an examination image with appropriate resolution while a load on a network is reduced.

To solve the above and other objects, the apparatus for providing medical support according to an aspect of the present invention comprises a distributor, a selector, a delivery image generator, and a distribution controller. The distributor transmits a medical image. The selector determines at least one first support medical staff and at least one second support medical staff. Medical support based on the medical image is requested to the first support medical staff. The at least one second support medical staff provides medical support not based on the medical image. The first and second support medical staffs participate in the medical support through respective terminals. The delivery image generator produces a first medical image as the medical image and produces a second medical image as the medical image. Image quality of the second medical image is lower than that of the first medical image. The distribution controller controls the distributor to transmit the first medical image to the terminal of the first support medical staff and transmit the second medical image to the terminal of the second support medical staff.

It is preferable that the first and the second medical images are produced by resizing an examination image obtained with an examination device.

It is preferable that the terminals are mobile terminals.

It is preferable that the selector automatically determines a doctor as the first support medical staff, out of registered support medical staffs.

It is preferable that the selector automatically determines a support medical staff other than the first support medical staff, out of the registered support medical staffs, as the second support medical staff.

It is preferable that the selector retrieves a support medical staff appointed by a primary care physician that requests the medical support or a support medical staff satisfying a requirement specified by the primary care physician, and determines the retrieved support medical staff as the first support medical staff.

A method for providing medical support comprising a determining step, a producing step, and a transmitting step. In the determining step, at least one first support medical staff and at least one second support medical staff are determined. Medical support based on an medical image is requested to the at least one first support medical staff. The at least one second support medical staff provides medical support not based on the medical image. The first and second support medical staffs participate in the medical support through respective terminals. In the producing step, a first medical image is produced as the medical image and a second medical image is produced as the medical image. Image quality of the second medical image is lower than that of the first medical image. In the transmitting step, the first medical image is transmitted to the terminal of the first support medical staff. The second medical image is transmitted to the terminal of the second support medical staff.

It is preferable that the first and the second medical images are produced by resizing an examination image.

It is preferable that the first support medical staff is a doctor included in registered support medical staffs.

It is preferable that the first support medical staff is a person, appointed by a primary care physician that requests the medical support, or a registered support medical staff satisfying a requirement specified by the primary care physician.

According to the present invention, the medical image with the image quality required for the diagnosis or the like is transmitted to the support medical staff who provides the medical support based on the medical image. The medical image with low image quality is transmitted to the support medical staff who does not need the medical image in providing the medical support. Thereby a load on the network is reduced.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic drawing illustrating a configuration of a medical support system;

FIG. 2 is a schematic drawing illustrating a structure of a registered support medical staff database;

FIG. 3 is a schematic drawing illustrating a structure of a destination database;

FIG. 4 is a block diagram illustrating a function of a medical support apparatus;

FIG. 5 is a block diagram illustrating a function of a support terminal in a medical support consultation;

FIG. 6 is an explanatory view illustrating a medical support request screen displayed on an in-hospital terminal;

FIG. 7 is an explanatory view illustrating a medical support request receiving screen of a tablet terminal;

FIG. 8 is an explanatory view of a display on a remark bulletin board of the tablet terminal;

FIG. 9 is an explanatory view illustrating a remark input screen of the tablet terminal;

FIG. 10 is an explanatory view illustrating an examination image display screen of the tablet terminal;

FIG. 11 is an explanatory view illustrating the in-hospital terminal displaying an electronic chart and a time series display screen;

FIG. 12 is a flowchart illustrating steps for requesting medical support;

FIG. 13 is a flowchart illustrating steps for the medical support consultation; and

FIG. 14 is a flowchart illustrating steps for controlling distribution of a high quality image and a low quality image.

### DESCRIPTION OF THE PREFERRED EMBODIMENTS

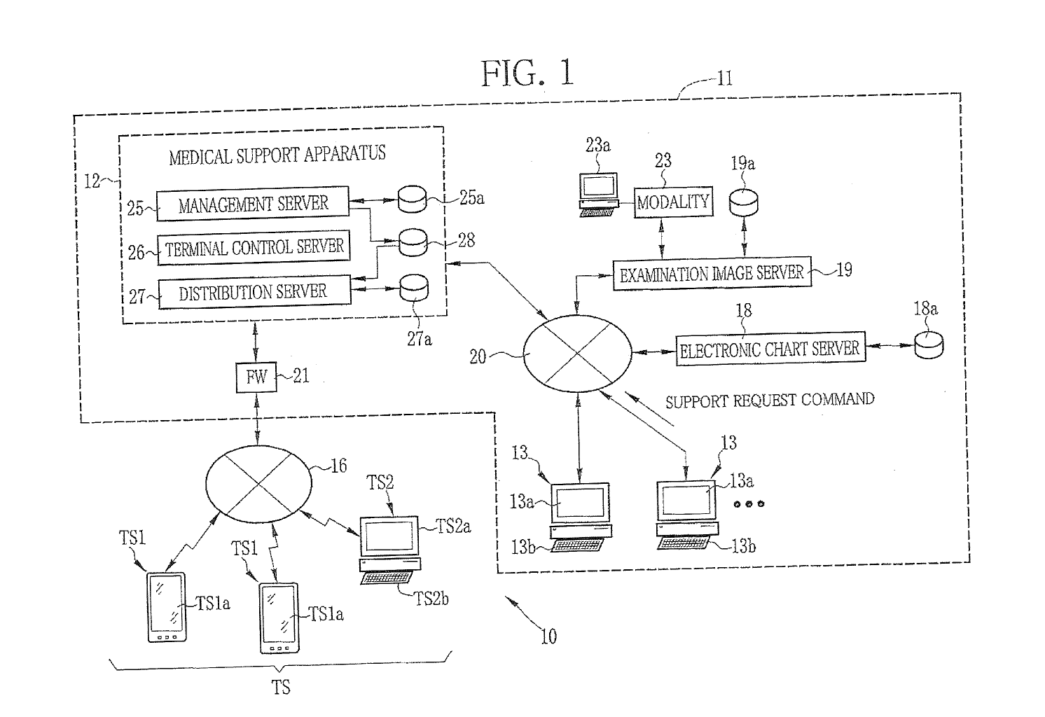

In FIG. 1, a medical support system 10 allows a registered support medical staff to provide medical support related to diagnosis, treatment, a medical task, and the like to a primary care physician. The medical support system 10 comprises an in-hospital subsystem 11 built in a hospital and support terminals TS (TS1 and TS2) connected to the in-hospital subsystem 11. The in-hospital subsystem 11 has a medical support apparatus 12 through which the medical support is provided.

In the medical support system 10, a medical support consultation is held using the medical support apparatus 12 when a primary care physician of the hospital requests the medical support through an in-hospital terminal 13 of the in-hospital subsystem 11. The medical support consultation is held per case of a patient, being an outpatient, an inpatient, an emergency patient delivered by ambulance, or the like. The medical support consultation relates to a disease or an injury which is difficult for the primary care physician to diagnose and treat. In the medical support consultation, the primary care physician who requested the medical support and a support medical staff who accepted the request exchange findings, remarks, and the like related to the treatment of the patient and give instructions while referring to medical information of the patient with the use of their respective terminals.

The medical support in this embodiment includes diagnosis and treatment performed by the support medical staff in place of a primary care physician and advice on the diagnosis and treatment from the support medical staff to the primary care physician, reporting the condition of the patient, treatment based on an instruction of a doctor, arranging facilities for an examination, treatment, a medical procedure, hospitalization, or the like, and communication related to an examination, treatment, a medical procedure, hospitalization, or the like. The support medical staff may be any medical or health personnel, for example, a doctor, a nurse, or a lab technologist. The support medical staff may include a hospital clerk. Note that, in this example, the support medical staff registered on the medical support apparatus 12 in advance is referred to as the registered support medical staff. The support medical staff participating in a single medical support consultation is referred to as the participant.

A mobile terminal, for example, a tablet terminal TS1 carried by the registered support medical staff, a personal computer TS2 in home or office of the registered support medical staff, and the like are used as the support terminals TS. For example, a smartphone installed with an application (hereinafter referred to as the support application) exclusive for the medical support system is used as the tablet terminal TS1. The tablet terminal TS1 is provided with a display TS1a that displays various screens for the medical support consultation. The display TS1a is a touch screen. Various commands and texts for the medical support consultation or the like are inputted with a touch on the display TS1a.

The personal computer TS2 is installed with the support application. A monitor TS2a of the personal computer TS2 displays various screens for the medical support consultation. Various commands and texts (letters) for the medical support consultation or the like are inputted using a keyboard TS2b and a mouse.

Note that the support terminal TS may be any device having a communication function and capable of displaying various screens and allowing input as necessary. Various terminals such as a PDA (Personal Digital Assistant), a smartphone, a mobile phone, and a notebook PC can be used as the support terminals TS. The registered support medical staff who belongs to the same hospital as that of the primary care physician may provide the medical support using the in-hospital terminal 13. In this case, the in-hospital terminal 13 functions as the terminal for the registered support medical staff.

The support terminal TS is connected to the in-hospital subsystem 11 through a network 16. Any type of network can be used as the network 16 as long as it connects the support terminal TS and the in-hospital subsystem 11 in a communicable manner. The network 16 is, for example, the Internet, an exclusive line, a mobile phone line, a public wireless LAN, or a combination thereof. The support terminal TS within or outside the hospital communicates with the in-hospital subsystem 11 through the network 16. The support terminal TS and the in-hospital subsystem 11 are connected through VPN (Virtual Private Network) to prevent information leak, for example.

The in-hospital subsystem 11 is composed of the medical support apparatus 12, the in-hospital terminal 13, an electronic chart server 18 and an examination image server 19 for providing medical information, an in-hospital LAN 20, a firewall 21, and the like. The medical support apparatus 12, the in-hospital terminal 13, the electronic chart server 18, and the examination image server 19 are connected through the in-hospital LAN 20. The firewall 21 is provided between the network 16 and the medical support apparatus 12. In addition to or instead of the servers 18 and 19, a server suitable for medical information to be provided is used. For example, a server for providing results of a blood test or a pathologic examination may be used.

The in-hospital LAN 20 is a network built in the hospital using the Internet technology. The in-hospital LAN connects the medical support apparatus 12, the in-hospital terminal 13, and the servers 18 and 19 in a communicable manner. The firewall 21 permits only the communication for the medical support consultation between the support terminal(s) TS and the medical support apparatus 12 through the network 16. The firewall 21 blocks unauthorized access to the medical support apparatus 12 and other devices connected to the in-hospital LAN to prevent the information leak and alteration of data.

The in-hospital terminals 13 are disposed in examination rooms and treatment rooms of various departments, for example, surgery and internal medicine, and an emergency center in the hospital. The in-hospital terminal 13 is a personal computer on which an application is installed. The application includes a program for electronic charts, a program for requesting examination, and a program for the medical support. A monitor 13a of the in-hospital terminal 13 displays an electronic chart, a medical image, a medical support request screen for requesting the medical support, and various screens for the medical support consultation. A keyboard 13b and a mouse (not shown) of the in-hospital terminal 13 are used to refer to or input an electronic chart, request an examination such as X-ray imaging, refer to medical images, request the medical support, and input remarks during the medical support consultation, for example. By accessing the medical support apparatus 12 from the in-hospital terminal 13, data of a registered support medical staff is deleted or data of a new support medical staff is registered.

The in-hospital terminal 13 sends a medical support request command to the medical support apparatus 12 to request the medical support. The medical support request command is based on the setting and input provided through the medical support request screen. The medical support request command includes data for specifying destination(s) of the medical support request. Upon receiving the medical support request command from the in-hospital terminal 13, the medical support apparatus 12 starts the medical support consultation and delivers or transmits the medical support request including the medical information to each of the registered support medical staffs in a medical support group to request the registered support medical staffs to participate in the medical support consultation.

The electronic chart server 18 records and stores initial data and treatment data of each patient in an electronic chart database 18a and provides the data as necessary. The electronic chart server 18 stores the initial data as a initial data record in the electronic chart database 18a. The initial data record (initial data) includes the name, the date of birth, gender, the weight, and the height of a patient. The initial data record also includes a patient ID assigned to each patient. The patient ID is used for identifying the initial data record. A new initial data record is created for a new patient (patient with no patient ID) and stored in the electronic chart database 18a by inputting the initial data using a terminal (not shown) for new registration.

The electronic chart server 18 records the treatment data as a treatment data record in the electronic chart database 18a. A registration ID and the patient ID are stored in the treatment data record. The registration ID is issued by a registration terminal (not shown) at the start or the registration of treatment. The treatment data includes treatment history such as findings and prescriptions inputted to an electronic chart, examination data, vital signs, and a doctor ID of a primary care physician. When the treatment data includes an examination image, its ID (image ID) is also stored in the treatment data record.

A modality (examination device) 23, such as a CT device or an MRI device is connected to the examination image server 19. The examination image server 19 records and stores an examination image, such as a CT image obtained from the modality 23, in an examination image database 19a and provides the examination image as necessary. In this example, the medical images refer to the examination images taken with the modality 23. The medical images may include various images of tissue in a pathologic examination, an image of a lesion taken with an endoscope, or an electrocardiogram. The medical images are not limited to still images. The medical images may be moving images.

The examination image server 19 receives a request (examination request) of examination from the in-hospital terminal 13. The examination image server 19 displays an instruction corresponding to the examination request on an operation terminal 23a of the modality 23. An examination image of the patient taken by a technologist using the modality 23 is recorded as an examination image record in the examination image database 19a. The examination image record includes an image ID for identifying the examination image, an imaging time, a technologist ID assigned to the technologist who took the examination image, the registration ID, and the patient ID, in addition to the examination image.

When the medical support consultation is started, for example, the medical support apparatus 12 notifies the electronic chart server 18 and the examination image server 19 of the registration ID and the patient ID of the case of the patient, being the subject of the medical support consultation. Thereafter the electronic chart server 18 sends an updated content of the electronic chart corresponding to the registration ID to the medical support apparatus 12 when the content of the electronic chart is updated. When a new examination image corresponding to the patient ID is taken, the examination image server 19 sends the examination image to the medical support apparatus 12. Thereby, the updated content of the electronic chart and the new examination image are transmitted or delivered automatically. Note that the primary care physician may manually transmit the updated content of the electronic chart and the new examination image.

The medical support apparatus 12 is composed of a management server 25, a terminal control server 26, a distribution server 27, and the like. The management server 25 registers a support medical staff or cancels the registration of a registered support medical staff, authenticates a registered support medical staff before or when he/she participates in the medical support, and manages participation of the registered support medical staff in the medical support consultation. A registered support medical staff database 25a is connected to the management server 25. The registered support medical staff database 25a stores data related to the registered support medical staffs.

By accessing the management server 25 through the in-hospital terminal 13 or a management terminal (not shown), a new support medical staff is registered, data of a registered support medical staff is changed, or the registration of a registered support medical staff is canceled. When a new support medical staff is registered, the management server 25 creates a new registered support medical staff record and stores it in the registered support medical staff database 25a. When the registration of a registered support medical staff is cancelled, the management server 25 deletes the corresponding registered support medical staff record from the registered support medical staff database 25a.

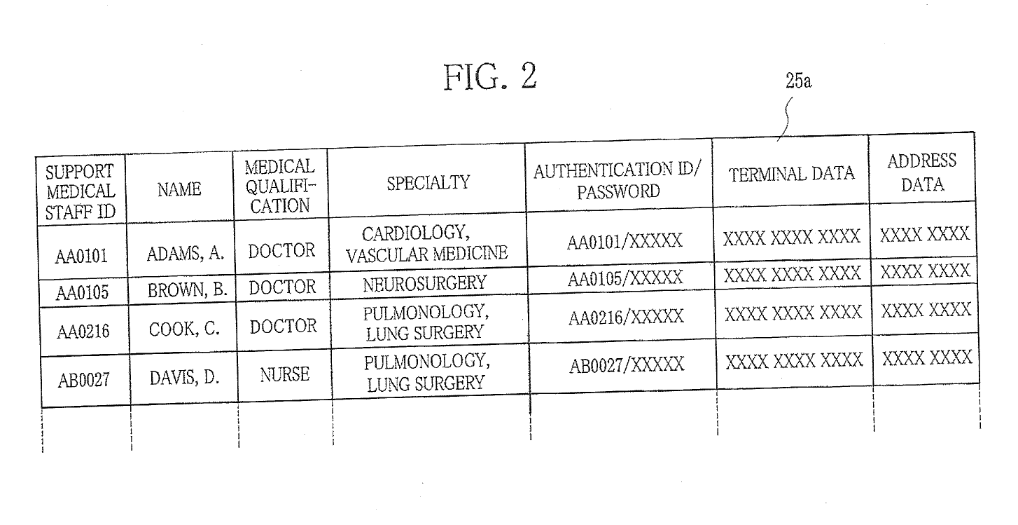

As shown in FIG. 2, a registered support medical staff ID for identifying the registered support medical staff, attribute information of the registered support medical staff, an ID (authentication ID) and a password for authentication, data (terminal data) of the terminal in use, address data of the terminal, and the like are stored in each registered support medical staff record in the registered support medical staff database 25a. The attribute information includes the name of the registered support medical staff, data (medical qualification data) of his/her medical qualification or job title, and data (specialty data) of his/her specialty. The medical qualification data specifies medical qualification or a task of the registered support medical staff, for example, “doctor”, “nurse”, “technologist”, “pharmacist”, or “hospital clerk”. The specialty data specifies the registered support medical staff's specialty and/or the department to which the registered support medical staff belongs. Examples of the specialty data include “cardiology and vascular medicine (heart and blood vessels)” “neurosurgery (brain surgery)”, and “pulmonology (respiratory medicine) and lung surgery”.

The terminal data is used to identify the support terminal TS used by the registered support medical staff. For example, a MAC (Media Access Control) address assigned to a network interface of the support terminal TS or a specific number called “IMSI (International Mobile Subscriber Identity)” stored in a SIM (Subscriber Identity Module) card for mobile phone in the tablet terminal TS1 is used as the terminal data. The address data indicates an address or destination of the terminal in use, for example, an IP address, a mail address, or a phone number of a mobile phone to which data is sent.

Note that the registered support medical staff records with different terminal data and address data may be stored for a single registered support medical staff so as to make two or more support terminals TS available for the registered support medical staff. The support terminal TS may be provided with different types of terminal data such as the MAC address and the IMSI. The terminal data compliant with the communication method is used for the authentication of the support terminal TS to participate in the medical support consultation.

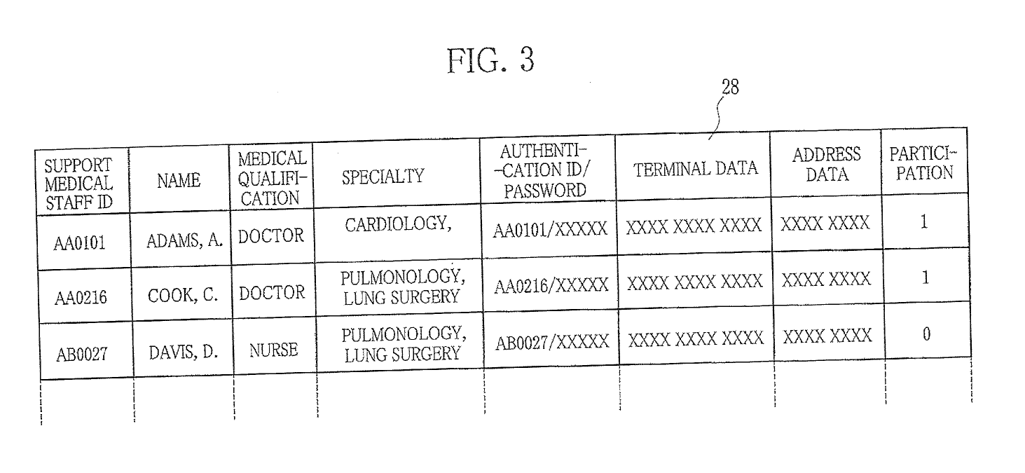

A destination database 28, in which destination records are stored, is connected to the management server 25. As shown in FIG. 3, the destination record in the destination database 28 is composed of the registered support medical staff record and a column for “participation” (participation column). The destination of each data, sent from the distribution server 27, is controlled by recording or storing the destination record in the destination database 28 and making a change in the participation column.

The terminal control server 26 controls the support terminal TS through the support application. For example, the terminal control server 26 deletes delivered data stored in the support terminal TS when the medical support consultation of a case is ended.

During the medical support consultation, the distribution server 27 delivers or transmits the medical information to each of the support terminals TS and the in-hospital terminal 13. The distribution server 27 generates a medical support request based on the medical support request command from the in-hospital terminal 13 and delivers the medical support request to each of the support terminals TS corresponding to the destination(s) specified. The medical support request includes initial data, being the medical information. After the medical support is requested, the distribution server 27 retrieves the necessary medical information and delivers or transmits the medical information to each of the primary care physician's in-hospital terminal 13 and the participants' support terminals TS. Here, the medical information includes an opinion or remark from the primary care physician or the participant, the updated content of the electronic chart, and a new examination image, for example.

The distribution server 27 generates the initial data based on command data included in the medical support request command from the in-hospital terminal 13. The initial data is included in the medical support request. The initial data includes the patient ID of the patient, being the subject of the medical support consultation, the registration ID of the case of the patient, the registration time, a medical support request comment inputted by the primary care physician, the examination image(s) taken with the modality 23 between the acceptance of the patient and the transmission of the medical support request command, and the content of the electronic chart pertaining to the case.

The distribution server 27 changes the size of a retrieved examination image to produce a high quality image, being an examination image of high image quality, and a low quality image, being an examination of low image quality. The distribution server 27 sends the high quality image to the support terminal TS of the support medical staff (the registered support medical staff or the participant) to whom the medical support based on the medical image is requested. The distribution server 27 sends the low quality image to the support terminal TS of the support medical staff to whom the medical support based on the examination image is not requested.

A delivered information database 27a is connected to the distribution server 27. The delivered information database 27a stores a delivered data record. The delivered data record includes the initial data and other data delivered to the support terminal TS and the in-hospital terminal 13. To be more specific, the delivered data record includes the registration ID, a delivery ID for identifying the data delivered, a delivery time, a time of receiving the data (a remark or an examination image) that is the source of the data delivered, and an ID (the primary care physician's ID or the support medical staff's ID) of a speaker who inputted an opinion or remark. When the delivered data is an examination image, its image ID and a device ID of the modality 23 used for imaging the examination image are stored in the delivered data record.

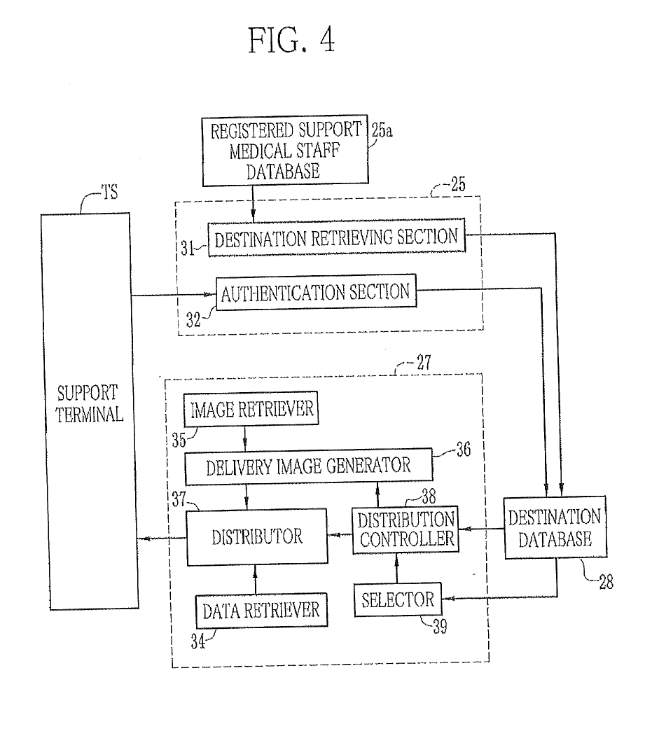

As shown in FIG. 4, the management server 25 functions as a destination retrieving section 31 and an authentication section 32. In response to the medical support request command from the in-hospital terminal 13, the destination retrieving section 31 retrieves the registered support medical staff record of the registered support medical staff corresponding to the destination selected or specified by the primary care physician through the in-hospital terminal 13. The destination retrieving section 31 adds the participation column to the retrieved registered support medical staff record and stores the retrieved registered support record with the participation column as the destination record in the destination database 28. Whether the registered support medical staff record matches the destination selected or specified is judged based on the medical qualification data and the specialty data in the registered support medical staff record. The registered support medical staff record which matches the specified destination or requirement(s) is retrieved.

Based on authentication data transmitted from the support terminal TS, the authentication section 32 judges whether the user of the support terminal TS is a valid registered support medical staff allowed to participate in the medical support consultation. To be more specific, the authentication section 32 authenticates the user as the valid registered support medical staff based on the authentication data, being an authentication ID, a password, and the terminal data. The authentication data is transmitted together with participation notification transmitted from the support terminal TS when the user participates in the medical support consultation after the delivery of the medical support request. In the authentication, the destination record which matches the transmitted terminal data is retrieved or identified in the destination database 28. The user is authenticated as the valid registered support medical staff when the authentication

ID and the password stored in the identified destination record match those transmitted from the support terminal TS. The user authenticated as the valid registered support medical staff is allowed to participate in the medical support consultation. The authentication section 32 writes a participation flag “1” into the participation column, indicating that this registered support medical staff participates in the medical support consultation. Note that application for the participation in the medical support consultation may be allowed for a certain period of time. Namely, the authentication section 32 authenticates the user(s) only within a predetermined period after the medical support request is delivered.

The distribution server 27 functions as a data retriever 34, an image retriever 35, a delivery image generator 36, a distributor 37, a selector 39, and a distribution controller 38. The data retriever 34 retrieves the medical information other than the examination image. To transmit the medical support request, the data retriever 34 obtains or retrieves the data, other than the examination image, necessary for the initial data based on the command data included in the medical support request command. After the medical support request is distributed or delivered, the data retriever 34 obtains the medical information such as remarks from the primary care physician and the participant and the updated content of the electronic chart. The data retriever 34 obtains the updated content of the electronic chart from the electronic chart server 18 using the registration ID as a key, for example. Note that the data (various pieces of medical information to be delivered) other than the examination image is referred to as standard data.

The image retriever 35 retrieves the examination image, which is to be transmitted along with the medical support request, from the examination image server 19. For example, the image retriever 35 uses the image ID as a key to retrieve the examination image, which is used as the initial data, from the examination image server 19. After the medical support request is delivered, the image retriever 35 receives the examination image from the examination image server 19.

The delivery image generator 36 performs a resize process on the examination image, retrieved by the image retriever 35, to produce the high quality image (first medical image) and the low quality image (second medical image) whose image quality is lower than that of the high quality image. The resize process is to reduce the number of pixels in an examination image. Although the number of pixels in the high quality image is reduced by the resize process in consideration of the display performance of the support terminal TS, the image quality of the high quality image is maintained at a level which allows the specialist to provide a reliable diagnosis based on the high quality image. The number of pixels in the low quality image is more reduced than that in the high quality image. The number of pixels in the low quality image is in the order of 1/10 of that in the high quality image, for example. Note that the low quality image may be produced by resizing the high quality image. Examples of the resize processes include reduction of a frame rate of moving images and the reduction of the number of pixels.

Under the control of the distribution controller 38, the distributor 37 delivers the standard data from the data retriever 34 and the high quality image or the low quality image produced in the delivery image generator 36. Based on the destination record in the destination database 28, the distribution controller 38 controls the distribution or transmission of the medical support request and the subsequent distribution or transmission.

The distribution controller 38 allows the distributor 37 to distribute or transmit the medical support request to an address indicated by the address data in each destination record in the destination database 28, for example. Thereby the medical support request is delivered to all the support terminal(s) TS corresponding to the support medical staff(s) (destination) appointed or selected by the primary care physician through the in-hospital terminal 13. After the medical support request is delivered, the distribution controller 38 allows the distributor 37 to distribute or transmit the medical information to each address of the destination record into which the participation flag “1” has been written, out of all the destination records stored in the destination database 28. Thereby the medical information is delivered only to the registered support medical staff who notified to participate in the medical support consultation and is authenticated, that is, the participant.

When or after the medical support request is delivered, the distribution controller 38 delivers the high quality image to each support terminal TS of the registered support medical staff or participant selected or determined by the selector 39, and delivers the low quality image to each support terminal TS of the registered support medical staff or participant not selected by the selector 39.

The selector 39 selects or determines the support medical staff (the registered support medical staff or the participant) to whom the medical support based on the delivered examination image is requested. To be more specific, “the medical support based on the examination image” includes diagnosing, advice, and support based on the examination image. In this example, the selector 39 goes through the destination records in the destination database 28 and automatically retrieves each registered support medical staff or participant with the medical qualification “doctor” as the support medical staff to whom the medical support based on the examination image is requested. The high quality image allowing the diagnosis and the like is delivered to each registered support medical staff (in this example, doctor) who provides the medical support based on the examination image. The low quality image is delivered to other registered medical staffs who do not provide the medical support based on the examination image.

Note that FIG. 4 illustrates how the standard data and the examination image are delivered from the medical support apparatus 12 to the support terminal TS. The standard data and the examination image are delivered unconditionally to the primary care physician's in-hospital terminal 13 that transmitted the medical support request command.

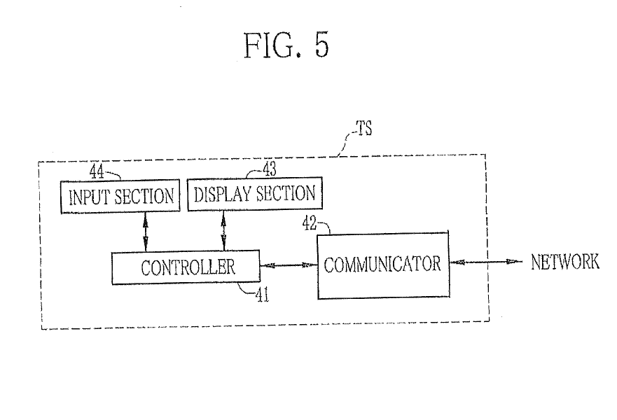

The support terminal TS is installed with the support application as described above. As shown in FIG. 5, execution of the support application allows the support terminal TS to function as a controller 41, a communicator 42, a display section 43, and an input section 44. The controller 41 controls the communicator 42, the display section 43, and the input section 44. The communicator 42 is composed of a communication circuit such as a network interface. The communicator 42 communicates with the medical support apparatus 12 through the network 16 and the firewall 21.

For example, the display section 43 of the tablet terminal TS1 is composed of the display TS1a and the like, and displays a medical support request receiving screen, a medical support consultation screen, or the like. The input section 44 of the tablet terminal TS1 is composed of a touch screen on the display TS1a, and the like. The input section 44 of the tablet terminal TS1 receives input through various operation buttons or a soft keyboard displayed on the display TS1a. The registered support medical staff provides input through the input section 44 to participate in the medical support consultation, input a remark during the medical support consultation, and refer to the examination image. The display section 43 of the personal computer TS2 is composed of the monitor TS2a and the like. The input section 44 of the personal computer TS2 is composed of the keyboard TS2b and the like. The display section 43 of the personal computer TS2 displays the screen in a manner similar to that of the tablet terminal TS1. The input section 44 of the personal computer TS2 is operated to provide input in a manner similar to that of the tablet terminal TS1.

At least a part of each of the controller 41 and the communicator 42 is kept turned on so as to receive the medical support request from the medical support apparatus 12 when the support terminal TS is turned on or in a “sleep” mode. In response to receiving the medical support request through the communicator 42, the controller 41 allows the display section 43 to display the medical support request receiving screen. Thereby, the medical support request is immediately displayed on each support terminal TS of the registered support medical staff. The registered support medical staff immediately corresponds to an urgent medical support request. Note that it is preferable to use sound, vibration, or the like to notify the registered support medical staff of the reception of the medical support request.

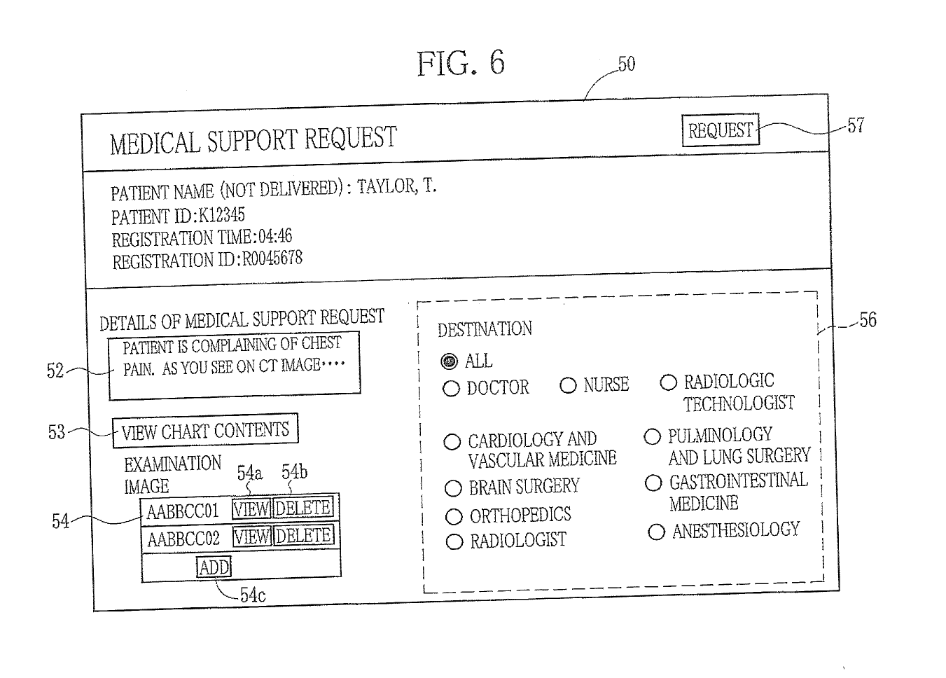

Next, screens displayed on the in-hospital terminal 13 and the support terminal TS during the medical support consultation are described. In FIG. 6, the monitor 13a of the in-hospital terminal 13 displays a medical support request screen 50. The medical support request screen 50 is displayed, for example, by a predetermined operation on an electronic chart screen of the in-hospital terminal 13. The medical support request command generated based on the setting and input provided on the medical support request screen 50 is sent from the in-hospital terminal 13 to the medical support apparatus 12.

The medical support request screen 50 displays a part of the contents of the electronic chart of a patient, being the subject of the medical support. The patient name, the patient ID, the registration time, and the registration ID displayed on the medical support request screen 50 are the same as those displayed on the electronic chart screen. Note that the patient ID, the registration time, and the registration ID are delivered with the medical support request from the distribution server 27 to each support terminal TS. The patient name, being information to identify an individual, is not delivered.

The primary care physician inputs a medical support request comment to a comment box 52. The medical support request comment is, for example, a comment describing a reason for requesting the medical support. When a chart content button 53 is clicked with the mouse, the in-hospital terminal 13 displays the contents of the electronic chart to be delivered with the medical support request, for example, a symptom, the primary care physician's findings, and a treatment history, out of all the contents of the electronic chart.

The medical support request screen 50 displays an examination image list 54 that is a list of the image IDs of the examination images to be delivered by the distribution server 27. The distribution server 27 delivers the examination image list 54 together with the medical support request. When the medical support request screen 50 is initiated, the in-hospital terminal 13 automatically accesses the examination image server 19, using the registration ID as a key. The in-hospital terminal 13 retrieves the image IDs of the examination images, pertaining to the medical support request, taken between the acceptance of the patient and the startup of the medical support request screen 50. The retrieved image IDs are displayed on the examination image list 54.

A view button 54a and a delete button 54b are displayed for each image ID on the examination image list 54. With a click on the view button 54a, the in-hospital terminal 13 retrieves a corresponding examination image from the examination image server 19 and displays it on the display. With a click on the delete button 54b, the corresponding image ID is deleted from the examination image list. Namely, the examination image with the deleted image ID is not delivered.

An add button 54c is displayed on the examination image list 54. The add button 54c is used to add an examination image to be delivered. With a click on the add button 54c, the in-hospital terminal 13 displays a screen (selection screen) for selecting examination image(s) pertaining to the case of the patient, being the subject of the medical support. The examination image selected on the selection screen is added as the examination image to be delivered. The image ID of the selected examination image is added to the examination image list 54. Thereby, the examination images necessary for the medical support are delivered.

The medical support request screen 50 displays a destination selection section 56 for selecting or specifying the registered support medical staffs (destination) to whom the medical support request is delivered. In this example, if the medical support request is to be delivered to all the registered support medical staffs, the primary care physician clicks on “all”. Instead, the registered support medical staffs are selected on a group basis according to a medical qualification or job title, a specialty, and/or a department, for example. By selecting an item or option (for example, the medical qualification, the specialty, or the department) on the destination selection section 56, one or more registered support medical staffs corresponding to the selected item are selected. The medical support request is transmitted to the selected registered support medical staff(s). As for the medical qualification, at least one of “doctor”, “nurse”, and “radiologic technologist” may be selected. As for the specialty and/or the departments, at least one of “cardiology and vascular medicine (heart and blood vessels)”, “neurosurgery (brain surgery)”, “pulmonology (respiratory medicine) and lung surgery”, “radiologist”, and the like may be selected. Two or more items can be selected at a time.

In response to a click on a delivery command button 57, the in-hospital terminal 13 sends the medical support request command to the medical support apparatus 12. The medical support request command includes the command data inputted and set through the medical support request screen 50. Namely, the selected destination(s) is sent to the management server 25. The registration ID, the medical support request comment, the image ID(s) selected from the examination image list 54 are transmitted to the distribution server 27. Based on the registration ID and the image ID(s), pieces of data to be delivered as the initial data are retrieved.

When the support terminal TS (TS1 or TS2) receives the medical support request from the distribution server 27, the display section 43 displays the medical support request receiving screen on the display TS1a or the monitor TS2a. Note that, during the medical support consultation, the screen displayed on the monitor TS2a of the personal computer TS2 is the same as that displayed on the display TS1a of the tablet terminal TS1. Hereinafter, the screen displayed on the display TS1a of the tablet terminal TS1 is described by way of example.

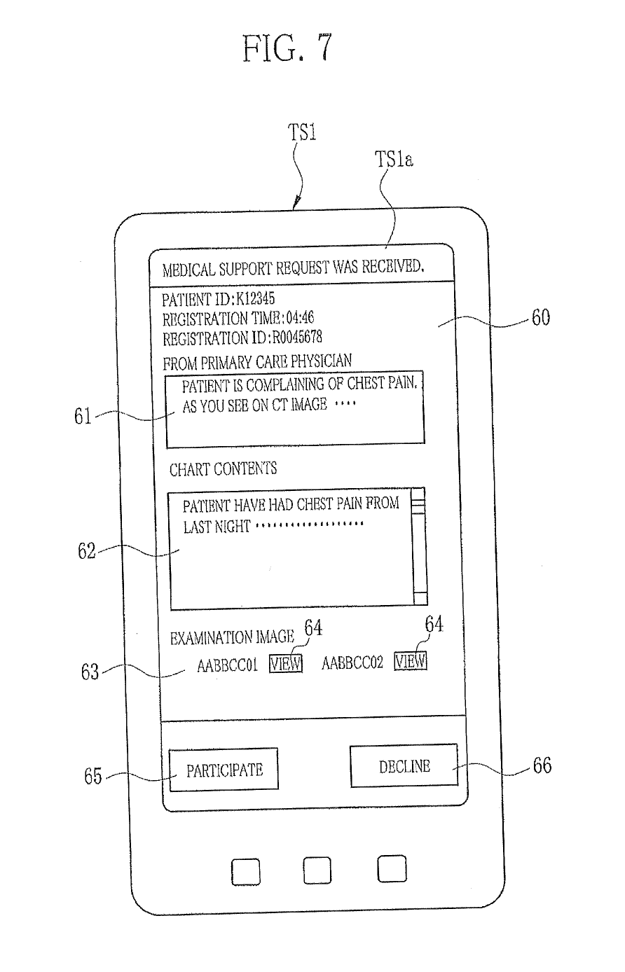

As shown in FIG. 7, the display TS1a displays a medical support request receiving screen 60 by way of example. The medical support request receiving screen 60 displays the initial data delivered from the distribution server 27. The initial data is included in the medical support request and includes the patient ID, the registration time, the registration ID, a medical support request comment 61 inputted in the comment box 52, chart contents 62 of the electronic chart pertaining to this case, and an examination image list 63 (corresponding to the examination image list 54).

The display section 43 displays image view button(s) 64, a participation button 65, and a decline button 66 on the medical support request receiving screen 60. The image view buttons 64 correspond to the respective image IDs in the examination image list 63. With a touch on the image view button 64, an examination image display screen opens and the examination image corresponding to the image view button 64 is displayed on the display TS1a. With a touch on the participation button 65, participation notification, notifying that the registered support medical staff using this support terminal TS participates in the medical support consultation, is sent to the medical support apparatus 12. With a touch on the decline button 66, decline notification, notifying that the registered support medical staff using this support terminal TS declines to participate in the medical support consultation, is sent to the medical support apparatus 12.

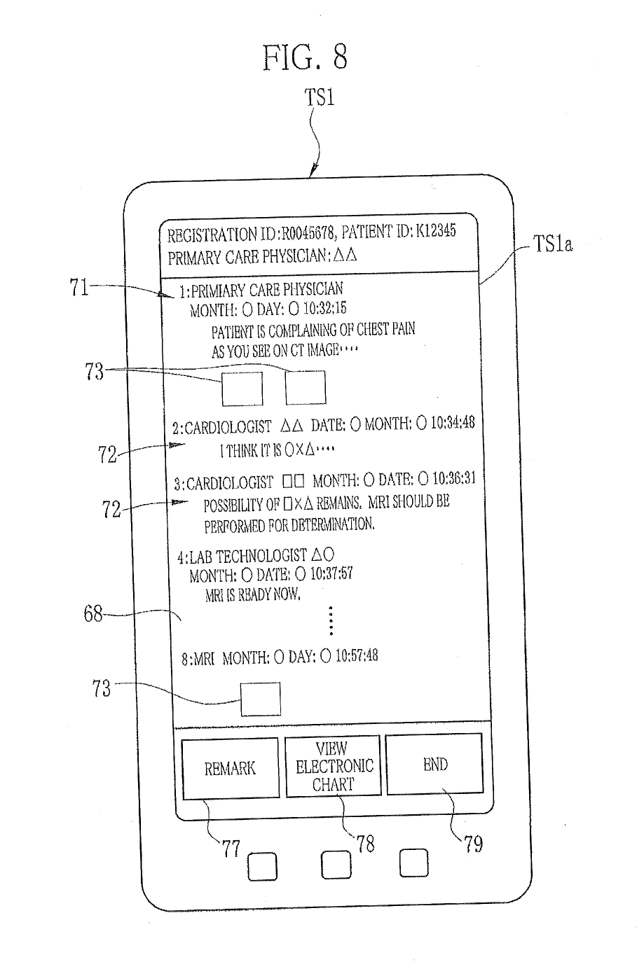

As shown in FIG. 8, when the medical support consultation is started, the display section 43 displays a remark bulletin board 68 on the display TS1a. On the remark bulletin board 68, a medical support request comment 71, remarks 72 of the primary care physician and the participants, a thumbnail image 73 of the examination image are arranged in time order in an electronic bulletin board method. The content displayed on the remark bulletin board 68 is updated every time a remark or an examination image is delivered to the support terminal TS.

The thumbnail images 73 of the examination images include the thumbnail image 73 of the examination image in the initial data and the thumbnail image 73 of the examination image automatically delivered. In this example, the thumbnail image 73 of the examination image included in the initial data is displayed along with the medical support request comment 71. The display section 43 reduces (pixel thinning) the size of the delivered examination image to produce the thumbnail image 73. With a touch on the thumbnail image 73, the screen is switched to the examination image display screen, on which the examination image corresponding to the touched thumbnail image 73 is displayed. Note that, for example, the distribution server 27 may produce the thumbnail image 73 and deliver it together with the examination image.

Above the remark bulletin board 68, the patient ID, the registration ID, and the name of the primary care physician who sent the medical support request are displayed. Below the remark bulletin board 68, a remark button 77, a chart view button 78, and an end button 79 are displayed. In response to a touch on the remark button 77, the display section 43 switches the screen to a remark input screen. In response to a touch on the chart view button 78, the display section 43 switches the screen to display the contents of the electronic chart. The end button 79 is operated to decline participation in or withdraw from the medical support consultation. In response to a touch on the end button 79, withdrawal notification is transmitted to the medical support apparatus 12. In response to the withdrawal notification, the management server 25 deletes the participation flag in the destination record corresponding to the support terminal TS which transmitted the withdrawal notification. Thereby the management server 25 stops the distribution or transmission of the medical information to the support terminal TS.

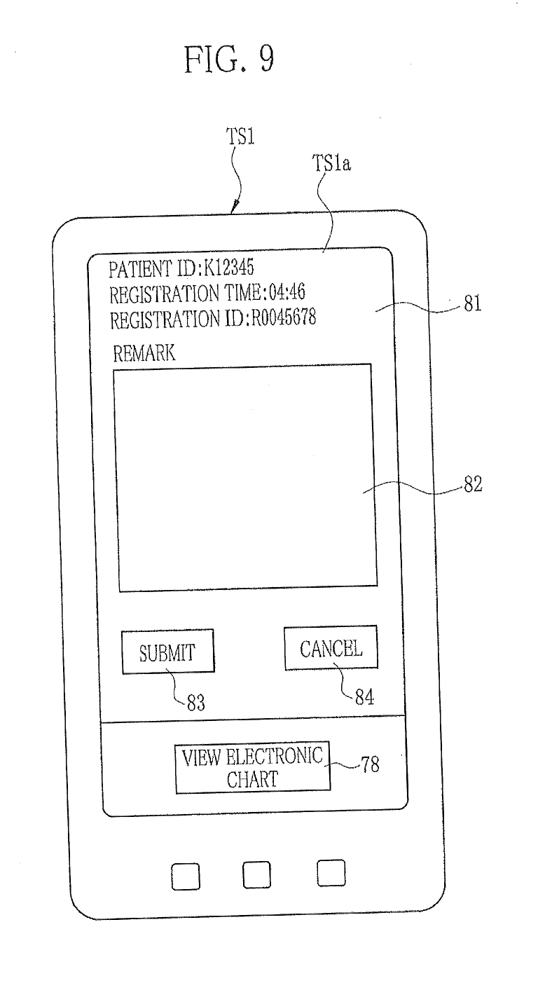

As shown in FIG. 9, a remark input screen 81 displays a remark box 82 in addition to the patient ID, the registration time, and the registration ID. An opinion or remark is inputted to the remark box 82 through the soft keyboard or the like on the input section 44 with the touch screen. In response to a touch on a submit button 83, the remark inputted to the remark box 82 is transmitted to the medical support apparatus 12 through the communicator 42. The distribution server 27 receives the remark, and delivers it to each of the participants' support terminals TS and the primary care physician's in-hospital terminal 13. A cancel button 84 is used to close the remark input screen 81 and return to the immediately preceding screen. The remark input screen 81 displays the chart view button 78. With a touch on the chart view button 78, the participant can view the contents of the electronic chart while inputting a remark in the remark box 82. Note that the remark input screen 81 may display the image view button used for viewing the examination image.

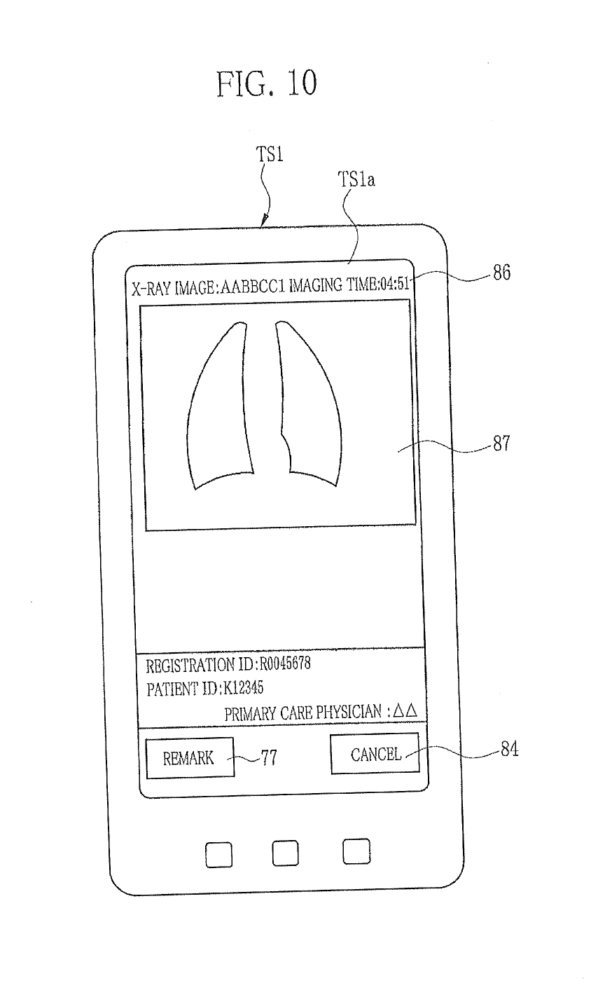

As shown in FIG. 10, an examination image display screen 86 displays the type of the examination image (for example, X-ray image, CT image, or the like), the image ID, the imaging time, and an examination image 87. The participant views the examination image 87 on the examination image display screen 86. The examination image 87 is the high quality image or the low quality image delivered from the medical support apparatus 12. Note that a toolbar is displayed when a CT image or an MRI image is displayed. The tool bar is used to control a cross-section or an orientation of the examination image displayed. With the use of the tool bar, a desired cross-section of the examination image 87 is viewed in a desired orientation.

The examination image display screen 86 displays the remark button 77 and the cancel button 84. The functions of the remark button 77 and the cancel button 84 are the same as those of the remark button 77 and the cancel button 84 described in FIGS. 8 and 9. Note that the remark button 77 is not displayed when the examination image display screen is opened using the image view button 64 on the medical support request receiving screen 60.

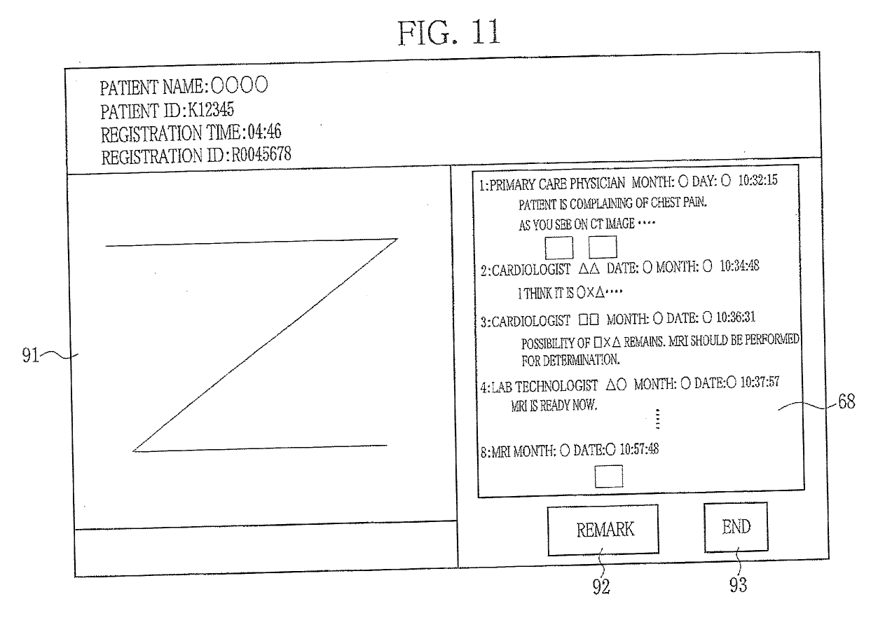

As shown in FIG. 11, after the medical support consultation is started, the monitor 13a of the in-hospital terminal 13 displays an electronic chart 91 and the remark bulletin board 68. The same remark bulletin board 68 as that displayed on the support terminal TS is displayed on the monitor 13a of the in-hospital terminal 13. Thereby, the primary care physician can share and understand the remarks of the participants easily. The monitor 13a of the in-hospital terminal 13 also displays a remark button 92 and an end button 93. With the operation of the remark button 92, the primary care physician inputs and sends a remark during the medical support consultation. The remark is transmitted from the in-hospital terminal 13 to the medical support apparatus 12 through the in-hospital LAN 20. The end button 93 is used to transmit an end notification, notifying the end of the medical support consultation, from the in-hospital terminal 13 to the medical support apparatus 12. In response to the end notification, the medical support apparatus 12 executes a predetermined end sequence to end the medical support consultation.

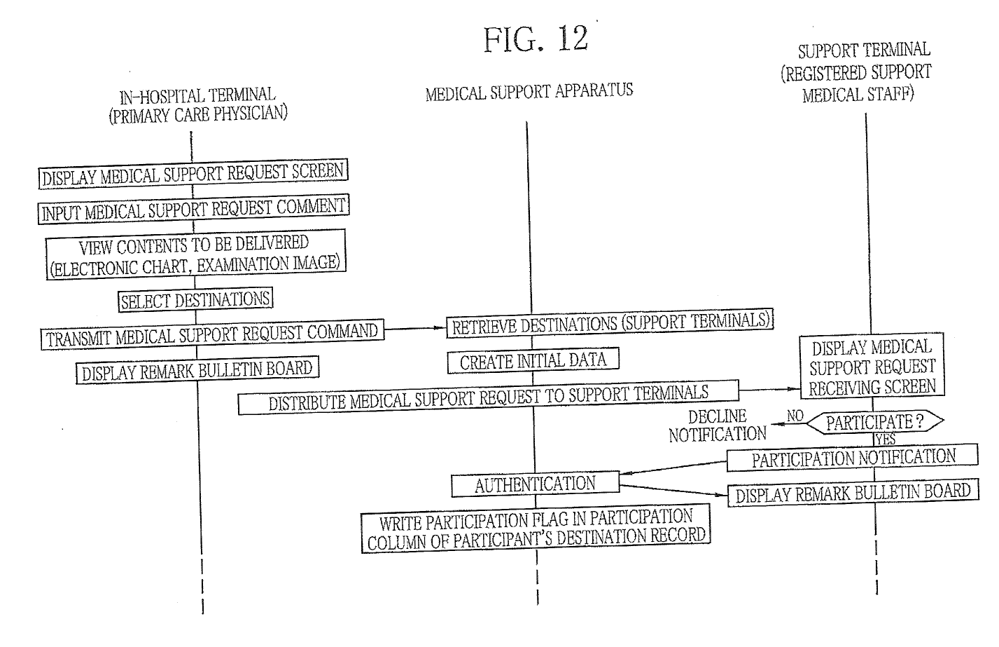

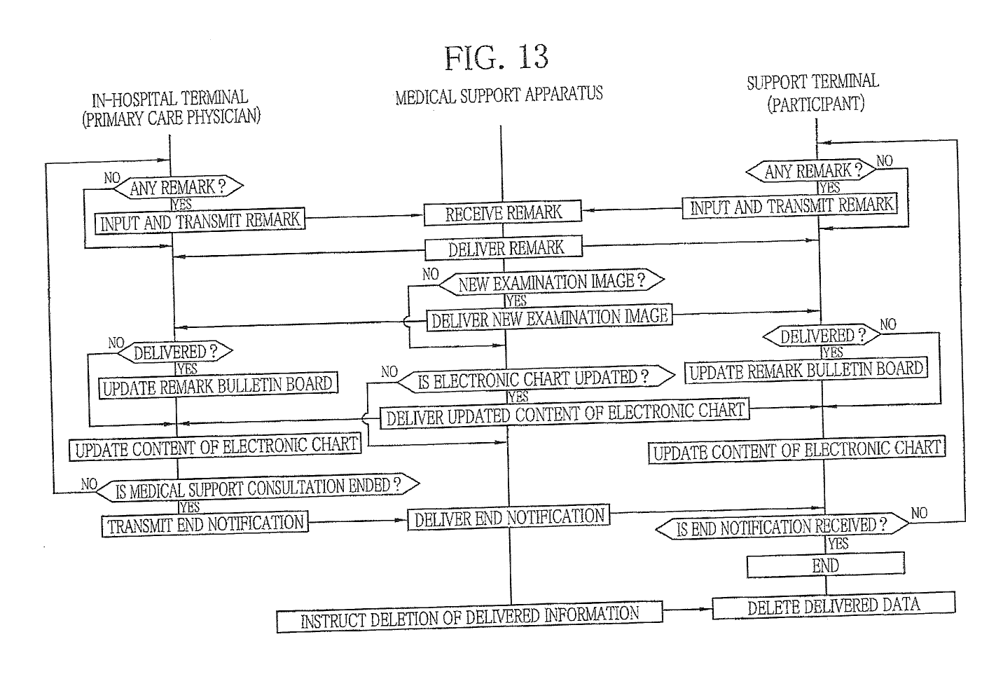

Referring to FIGS. 12 and 13, an operation of the above-configured medical support system 10 is described. For example, the medical support using the medical support system 10 is requested when a doctor needs advice on diagnosis or treatment of a disease or injury of a patient from a specialist or a radiologist, for example. Note that the patient or the subject of the medical support consultation may be an outpatient, an emergency outpatient in out-of-office hours, an emergency patient delivered by ambulance, or an inpatient, for example.

For example, when the primary care physician needs the medical support on treatment (hereinafter may referred to as the case) of the patient currently treated, the primary care physician operates the in-hospital terminal 13. The primary care physician performs a predetermined operation on the electronic chart screen to display the medical support request screen 50 shown in FIG. 6. The medical support request screen 50 corresponds to the case of the patient. There is no need for the primary care physician to input or select the patient ID and the registration ID assigned at the time of the registration of the case.

After the medical support request screen 50 is displayed, the primary care physician inputs the medical support request comment to the comment box 52. The medical support request comment may include any type of content, for example, a reason for the medical support request or the content of the advice the primary care physician needs. The primary care physician clicks on the chart content button 53 to view and check the content of the electronic chart to be delivered. Using the registration ID as a key, the in-hospital terminal 13 retrieves the content to be delivered, out of the contents of the electronic chart of the case, from the electronic chart server 18. The in-hospital terminal 13 displays the content retrieved. If there is content to be added to the electronic chart, the primary care physician adds the content to the electronic chart, or inputs “the content needs to be added” as the medical support request comment to the comment box 52.

The examination image list 54 displays the image IDs of the respective taken examination images, corresponding to the case, retrieved from the electronic chart. To view or check the examination image, the primary care physician clicks on the view button 54a. In response to this, the in-hospital terminal 13 retrieves the examination image, having the image ID corresponding to the view button 54a clicked, from examination image server 19 and displays the examination image retrieved. If the displayed examination image is unnecessary, the examination image is closed, and the delete button 54b corresponding to the examination image is clicked. Thereby, the image ID of the examination image is deleted from the examination image list 54. Note that, if the examination image is to be delivered, no additional operation is necessary after the examination image is closed.

The add button 54c is clicked to deliver the examination image taken in the past treatment with the medical support request, for example. In response to this, the in-hospital terminal 13 displays a selection screen. The selection screen displays the examination images of the patient, stored in the examination image database 19a, in thumbnail images, for example. The primary care physician refers to the thumbnail images of the examination images and selects the thumbnail image of the necessary examination image. When the examination image is selected, the image ID of the selected examination image is displayed on the examination image list 54. The above-described operation is repeated to add two or more examination images.

The primary care physician clicks on the delivery command button 57, for example, after he/she selects one or more destinations (one or more support medical staffs), in accordance with the content of the support, through the destination selection section 56. In response to the click, the medical support request command is sent from the in-hospital terminal 13 to the medical support apparatus 12. The medical support request command is based on the input and settings provided through the medical support request screen 50. The medical support request command has the command data including the patient ID, the registration time, the registration ID, the medical support request comment, and the image IDs displayed on the examination image list 54. The name of the primary care physician who sent the medical support request command is also transmitted together with the medical support request command. As shown in FIG. 11, after the medical support request command is transmitted, the remark bulletin board 68 is displayed on the in-hospital terminal 13.

When the medical support apparatus 12 receives the medical support request command, data of the selected one or more support medical staffs (destination), out of the command data, are sent to the management server 25. The destination retrieving section 31 of the management server 25 accesses the registered support medical staff database 25a and retrieves the registered support medical staff records of the registered support medical staffs included in the group specified as the destination. For example, when the “doctor” is specified as the destination, each registered support medical staff record with the medical qualification or job title “doctor” is retrieved. When the “pulmonology and lung surgery” is specified as the destination, each of the medical staff records of the doctors and nurses with the specialty data of “pulmonology and lung surgery” is retrieved. When the “radiologist” is selected as the destination, each registered support medical staff record of a doctor with the specialty data of “radiologist” is retrieved. Note that when “all” is selected as the destination, all the registered support medical staff records stored in the registered support medical staff database 25a are retrieved.

The participation column is added to the retrieved registered support medical staff record to produce the destination record. The destination record is stored in the destination database 28. A nonparticipation flag “0” is displayed as the default in the participation column of each destination record. The nonparticipation flag “0” denotes that the registered support medical staff does not participate in the medical support consultation.

Out of the command data, the registration ID, the medical support request comment, and the image IDs in the examination image list 54 are sent to the distribution server 27. The data retriever 34 of the distribution server 27 retrieves the content of the electronic chart corresponding to the registration ID from the electronic chart server 18. The standard data, out of the initial data transmitted at the time of requesting the medical support, is produced.

The image retriever 35 retrieves the examination image corresponding to the image ID from the examination image server 19. The delivery image generator 36 performs the resize process on the retrieved examination image to produce the high quality image and the low quality image. The high and low quality images are delivered as the initial data.

The distributor 37 delivers the medical support request to the support terminal(s) TS through the firewall 21 and the network 16. The medical support request includes the initial data. The initial data is composed of the standard data produced as described above and the high or low quality image. Under the control of the distribution controller 38, the medical support request is delivered to the address indicated by the address data of each destination record in the destination database 28.

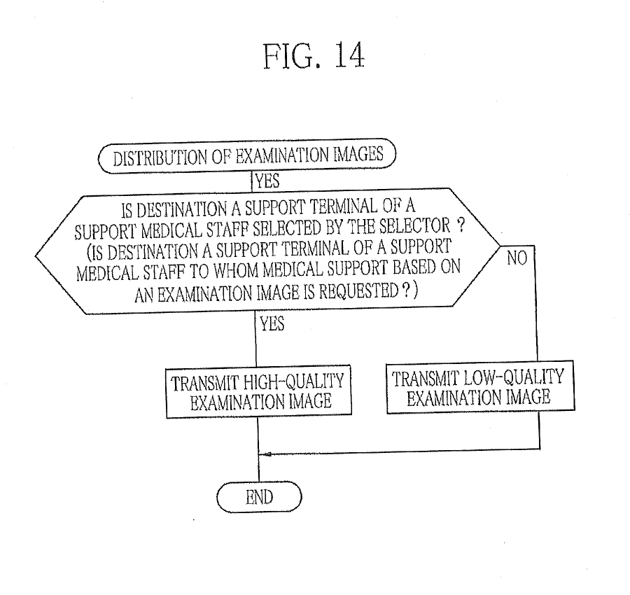

The selector 39 refers to the medical qualification or job title in each destination record, and selects the registered support medical staff(s) with the medical qualification “doctor”. As shown in FIG. 14, the distribution controller 38 delivers the examination image of the initial data to the support terminal(s) TS of the selected registered support medical staff(s) in accordance with the result of the selection. Namely, the distribution controller 38 allows the distributor 37 to send the high quality image to each support terminal TS of the registered support medical staff selected by the selector 39. The distribution controller 38 allows the distributor 37 to send the low quality image to each support terminal TS of the registered support medical staff not selected by the selector 39. The delivered medical support request including the initial data is stored as the delivered data record in the delivered information database 27a.

For example, when “all” is selected as the destination of the medical support request, the medical support based on the examination image is requested to all the doctors out of the registered support medical staffs. The initial data including the high quality image is sent to each of the doctor's support terminals TS. The initial data including the low quality image is sent to each of the registered support medical staffs such as nurses and radiologic technologists other than the doctors. For example, when “pulmonology (respiratory medicine) and lung surgery” is selected as the destination, the initial data including the high quality image is transmitted to each of the support terminals TS of the doctors with the specialty of pulmonology and lung surgery. The initial data including the low quality image is transmitted to each of the support terminals TS of the nurses with the specialty of pulmonology and lung surgery.

The low quality image is sent to the registered support medical staff who does not provide the medical support based on the examination image. Thereby, the load on the network 16 between the distribution server 27 and the support terminals TS is reduced. The time for receiving the data using the tablet terminal TS1, being the wirelessly connected support terminal TS, is reduced.

A part of every support terminal TS is kept turned on to receive the medical support request. The support terminal TS corresponding to the destination receives the medical support request. The support terminal TS which received the medical support request displays the medical support request receiving screen 60 shown in FIG. 7.

The registered support medical staff, using the support terminal TS on which the medical support request receiving screen 60 is displayed, refers to the medical support request comment 61 and the chart contents 62 displayed on the medical support request receiving screen 60. When necessary, the registered support medical staff touches or clicks on the image view button 64 of the examination image list 63 to open the examination image display screen and refer to the examination image.

The high quality image is automatically sent to the support terminal TS of the registered support medical staff (in this example, the doctor) to whom the medical support based on the examination image is requested. The doctor makes careful observation of the high quality image. Appropriate diagnosis or decision is difficult when the examination image with the required resolution cannot be obtained, for example, when the resolution of the examination image is determined based on the performance of the support terminal TS or its environment or when examination images of low resolution are distributed uniformly. In this example, such problem is avoided.

The registered support medical staff to whom the medical support request is delivered decides whether to participate in the medical support consultation according to his/her schedule, experience, or the like. The participation button 65 or the decline button 66 is touched according to the decision.

For example, when the registered support medical staff who uses the tablet terminal TS1 as the support terminal TS declines to participate in the medical support consultation, he/she touches the decline button 66. In response to this, the decline notification is transmitted from the tablet terminal TS1 to the medical support apparatus 12. A change is not made in the participation column of the destination record when the medical support apparatus 12 receives the decline notification. Namely, the nonparticipation flag “0” is maintained. The remarks and the like pertaining to the medical support consultation are not delivered to the tablet terminal TS1 from which the decline notification is transmitted. After the decline notification is transmitted, the medical support request receiving screen 60 closes.

When the registered support medical staff has decided to participate in the medical support consultation, he/she touches the participation button 65. In response to this, the display TS1a displays a screen (not shown) to which the authentication ID and the password are inputted. The registered support medical staff uses the soft keyboard to input the predetermined authentication ID and the password. Then, the submit button is touched.

When the submit button is touched, the tablet terminal TS1 transmits the authentication ID, the password, and the participation notification to the medical support apparatus 12 through the network 16 and the firewall 21.

The management server 25 receives the authentication ID and the password from the support terminal TS (in this example, the tablet terminal TS1). The authentication section 32 of the management server 25 identifies the support terminal TS, which sent the authentication ID and the password, from the data received along with the authentication ID and the password. Then, the destination record having the terminal data which corresponds to the identified support terminal TS is retrieved from the destination database 28. The authentication section 32 determines whether the authentication ID and the password stored in the destination record match the authentication ID and the password sent from the support terminal TS.

For example, when the authentication ID or the password does not match, a message is sent to the tablet terminal TS1 through the distribution server 27. The message notifies the user that the authentication ID or the password is incorrect and prompts the user to input the correct authentication ID or the password. Note that, when the destination record (the registered support medical staff record) having the terminal data which corresponds to the identified support terminal TS is not found, the support terminal TS displays that the support terminal TS in use is not registered, for example.

When the authentication IDs and the passwords match, the authentication section 32 judges that the user of the support terminal TS is a valid registered support medical staff and permits the user as the participant of the medical support consultation. The participant flag “1” is written into the participation column of the destination record of the participant. The above-described process is performed every time the authentication ID, the password, and the participation notification are received from the support terminal TS.

The distribution server 27 sends notification of normal completion of the authentication to the participant's tablet terminal TS1 when the participation flag “1” is written into the participation column of the destination record corresponding to the participant's tablet terminal TS1. In response to this, as shown in FIG. 8, the display TS1a of the tablet terminal TS1 displays the remark bulletin board 68. When the participant has not made a remark, the remark bulletin board 68 displays the medical support request comment 71 and the thumbnail image 73 of the examination image list 54 based on the initial data.

To input an opinion or remark, the participant touches the remark button 77 located below the remark bulletin board 68. In response to this, the remark input screen 81 is displayed. After inputting the remark such as advice and/or findings into the remark box 82, the participant touches the submit button 83. Thereby, the remark inputted to the remark box 82 is transmitted to the medical support apparatus 12.

Note that, to view the examination image after the remark bulletin board 68 is displayed, the participant touches the thumbnail image 73 displayed on the remark bulletin board 68. Thereby the examination image display screen 86 opens. To display the content of the electronic chart, the participant touches the chart view button 78.

The data retriever 34 of the distribution server 27 sends the remark from the tablet terminal TS1 to the distributor 37. Under the control of the distribution controller 38, the remark is delivered to the address indicated by the address data in the destination record, in the destination database 28, in which the participation flag in the participation column is “1” and the primary care physician's in-hospital terminal 13. The delivered remark is recorded as the delivered data record in the delivered information database 27a.

Note that when the participant uses the personal computer TS2 as the support terminal TS, the participant clicks the mouse, instead of the touch operation, to transmit the participation/decline notification, view the examination image, and the like. The participant uses the keyboard TS2b to input the opinion or remark.

When the support terminal TS and the primary care physician's in-hospital terminal 13 receive the remark from the distribution server 27, the display of the remark bulletin board 68 of each of the support terminal TS and the primary care physician's in-hospital terminal 13 is updated to display the received remark 72. A similar process is performed every time a remark is transmitted from the support terminal TS. Thereby the new remark 72 is displayed. A similar process is performed every time the primary care physician operates the remark button 92 to transmit his/her remark from the primary care physician's in-hospital terminal 13.

When an examination image of the patient, being the subject of the medical support consultation, is taken with the modality 23, the examination image server 19 checks the patient ID, and then the taken examination image is sent to the distribution server 27. The image retriever 35 receives the examination image. Based on the examination image, the delivery image generator 36 produces the high quality image and the low quality image. Under the control of the distribution controller 38, the high quality image or the low quality image is delivered from the distributor 37 to each of the address in address data of the destination record into which the participation flag “1” has been written and the primary care physician's in-hospital terminal 13 in a manner similar to the examination image of the initial data. To be more specific, in this case, the doctors are the participants to whom the medical support based on the examination image is requested. Hence, the high quality image is transmitted to each of the doctor's support terminals TS. The low quality image is transmitted to each of the support terminals TS of the participants other than the doctors. Thereby, the load on the network 16 is reduced.

The thumbnail image 73 of the delivered examination image is displayed on the remark bulletin board 68 of each of the support terminal TS1 shown in FIG. 8 and the in-hospital terminal 13 shown in FIG. 11. A click or a touch on the thumbnail image 73 opens the examination image display screen 86 that displays the delivered examination image. Every time an examination image of the patient, being the subject of the medical support consultation, is taken with the modality 23, the examination image is delivered and the thumbnail image 73 corresponding to the delivered examination image is displayed on the remark bulletin board 68 in a manner similar to the above.

When the primary care physician operates the in-hospital terminal 13 to input content to the electronic chart, the electronic chart server 18 adds the inputted content to the treatment data record in the electronic chart database 18a. Based on the registration ID, the electronic chart server 18 detects that the treatment data record to which the content is added corresponds to the case of the patient, being the subject of the medical support, and sends the added content to the distribution server 27. The distribution server 27 delivers the added content to each of the participants' support terminals TS in a manner similar to the remarks and examination images. The contents, including the added content, of the electronic chart are displayed using the chart view button 78.

The primary care physician and the participants input and exchange opinions and the participant advises the primary care physician while referring to the remarks displayed on the remark bulletin board 68 and the examination image displayed on the examination image display screen 86. Thereby, the primary care physician provides appropriate diagnosis and treatment. Similar to the examination image delivered along with the medical support request, the examination image with the high image quality is displayed on the examination image display screen 86 of the support terminal TS of the participant (doctor) to whom the medical support based on the examination image is requested. The high quality image allows the participant (doctor) to examine it carefully.

When the participant needs to withdraw from the medical support consultation underway, the participant touches the end button 79. In response to this, the withdrawal notification is transmitted from the participant's support terminal TS to the medical support apparatus 12. The management server 25 changes from the participation flag to the nonparticipation flag in the participation column of the destination record corresponding to the support terminal TS which transmitted the withdrawal notification. Thereby, the distribution server 27 stops delivering the remarks and the like to the support terminal TS which transmitted the withdrawal notification. The delivered data, pertaining to the case, stored in the support terminal TS which transmitted the withdrawal notification is deleted under the control of the terminal control server 26 through the network 16.

The primary care physician touches the end button 93 on the in-hospital terminal 13 to end the medical support consultation when the treatment is completed with the sufficient medical support, for example. In response to this, the end notification notifying the end of the medical support is sent to the medical support apparatus 12. The distribution server 27 delivers the end notification to each of the participants' support terminals TS. The delivered data, pertaining to the case, stored in each support terminal TS is deleted under the control of the terminal control server 26 through the network 16.

In the above examples, all the doctors are automatically selected as the support medical staffs to whom the medical support based on the examination image is requested. Alternatively, the primary care physician may appoint the support medical staff(s) individually through the in-hospital terminal. For example, the primary care physician may appoint particular support medical staff(s). The primary care physician may choose “all” or “doctor” as the support medical staffs (destinations) to whom the medical support is requested. The primary care physician may choose or specify the specialty or the department of the doctors or the support medical staffs to whom the medical support based on the examination image is requested. The primary care physician may appoint or select support medical staff(s) for each examination image. The primary care physician may appoint or select a support medical staff, other than the doctor, to request the medical support based on the examination image.

Various changes and modifications are possible in the present invention and may be understood to be within the present invention.

What is claimed is:

1. An apparatus for providing medical support comprising:
a distributor for transmitting a medical image;
a selector for determining at least one first support medical staff and at least one second support medical staff, medical support based on the medical image being requested to the at least one first support medical staff, the at least one second support medical staff providing medical support not based on the medical image, the first and the second support medical staffs participating in the medical support through respective terminals;
a delivery image generator for producing a first medical image as the medical image and producing a second medical image as the medical image, image quality of the second medical image being lower than image quality of the first medical image; and
a distribution controller for controlling the distributor to transmit the first medical image to the terminal of the first support medical staff and transmit the second medical image to the terminal of the second support medical staff.

2. The apparatus of claim 1, wherein the first and the second medical images are produced by resizing an examination image obtained with an examination device.

3. The apparatus of claim 2, wherein the terminal is a mobile terminal.

4. The apparatus of claim 2, wherein the selector automatically determines a doctor as the first support medical staff, out of registered support medical staffs.

5. The apparatus of claim 4, wherein the selector automatically determines a support medical staff other than the first support medical staff, out of the registered support medical staffs, as the second support medical staff.

6. The apparatus of claim 1, wherein the selector retrieves a support medical staff appointed by a primary care physician that requests the medical support or a support medical staff satisfying a requirement specified by the primary care physician, and determines the retrieved support medical staff as the first support medical staff.

7. A method for providing medical support comprising the steps of:
(a) determining at least one first support medical staff and at least one second support medical staff, medical support based on an medical image being requested to the at least one first support medical staff, the at least one second support medical staff providing medical support not based on the medical image, the first and the second support medical staffs participating in the medical support through respective terminals;
(b) producing a first medical image as the medical image and producing a second medical image as the medical image, image quality of the second medical image being lower than image quality of the first medical image; and
(c) transmitting the first medical image to the terminal of the first support medical staff and transmitting the second medical image to the terminal of the second support medical staff.

8. The method of claim 7, wherein the first and the second medical images are produced by resizing an examination image obtained with an examination device.

9. The method of claim 8, wherein the first support medical staff is a doctor included in registered support medical staffs.

10. The method of claim 8, wherein the first support medical staff is a person appointed by a primary care physician that requests the medical support, or a registered support medical staff satisfying a requirement specified by the primary care physician.
